(19) United States
(12) Patent Application Publication
(10) Pub. No.: US 2007/0101017 A1
(43) Pub. Date: May 3, 2007

(54) System and method for routing information

(75) Inventor: Jay Ronald Dawson, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/261,591

(22) Filed: Oct. 31, 2005

(51) Int. Cl. G06F 15/173

(52) U.S. Cl. 709/238

(57) ABSTRACT

Systems and methods are disclosed for routing information in a work machine environment. In one embodiment, an information routing system is disclosed that includes a set of subscribers and an information router. The information router may be configured to store a set of parameter data received from a set of work machines operating in the work machine environment. The parameter data may reflect data associated with operation of each respective work machine. Further, the information router may filter the set of parameter data into subsets of parameter data based on information routing rules defined by each of the subscribers in the set of subscribers. Also, the information router may transmit the filtered subsets of parameter data to respective subscribers such that each subscriber only receives a portion of the set of parameter data based on each subscriber's corresponding information routing rule.

### TECHNICAL FIELD

This application relates generally to an information control and distribution system and, more particularly, to a system and method for routing information between a work machine and back-end systems.

### BACKGROUND

Work machines, such as excavators, track type tractors, loaders, dozers, motor graders, and other types of heavy machinery, typically include equipment to collect and transmit information associated with the operation and status of the machine in a work environment. The work machines may be connected to a communication network that interfaces with back-end systems, such as a communication platform that includes a centralized information server for gathering and storing data received from one or more of the work machines. This common communication platform provides a mechanism for users to access operational, status, and/or productivity data associated with one or more of the work machines.

In large work machine fleets, however, the flow of information on the network can be substantial, as each work machine provides a considerable amount of raw data to the server. As a result, additional resources are required that enable users and/or computer executed processes to analyze the large amount of received data. For example, a user may access the central server to obtain data corresponding to the operation of a particular type of work machine within a fleet of work machines. Because, however, the central server collects data from each of the work machines within the fleet, the user may be forced to sort through vast amounts of information to locate data associated with the particular work machine. Not only is such a practice cumbersome, it may also lead to the oversight of critical operational information, which could result in damage to a monitored work machine within the fleet. Furthermore, as work machines are added to the fleet, bandwidth and network management costs may increase, as additional infrastructure may be required to accommodate the size of the growing network.

One attempt to control the flow of information between a work machine and back-end systems is described in U.S. Patent Application Publication No. 2005/0021245 (“the '245 publication”) to Furuno et al. The '245 publication describes an information providing system including a server that collects data regarding machine operations of a plurality of construction machines. The server also directs the collected data to other systems over a communication network. In one instance, the server sends the data to a computer terminal for access by a user associated with the machine. In another instance, the server may provide the data to an intermediate server that subsequently distributes information to one or more users associated with the construction machine. An administrator (e.g., a dealer or owner) may optionally select the type of information that is distributed by the intermediate server, thus controlling access to the collected data by each user on the network.

Although the information providing system of the '245 publication may provide a platform for selectively configuring access to work machine information, it still suffers from the same efficiency problems experienced by other conventional systems. For example, the system only allows an administrator to control each user's access to the information maintained by the server, but does nothing to manage the congestion of information experienced by the server. Thus, the congestion of information at the server may lead to increased communication costs associated with managing and processing the information at the server and network. Furthermore, the information providing system of the '245 publication does not allow the end-users to define parameters that control how the server processes and delivers information. Thus, end-user systems may receive unneeded information. As a result, business processes that rely on real-time information provided by the work machines become inefficient because the end-users or end-user systems must sort and extract relevant data from the information received from the server.

The disclosed system and method for routing work machine information are directed towards overcoming one or more of the problems set forth above.

### SUMMARY OF THE INVENTION

Systems and methods are disclosed that perform information routing in a work machine environment. In one embodiment, an information routing system is disclosed that may include a work machine operating in the work machine environment configured to transmit operation data associated with operations of the work machine over a first communication network. The routing system may also include an information router configured to receive the operation data over the communication network, the information router including a database storing information routing rules that each govern how the information router is to collect and deliver information received from the work machine. The routing system may further include a first subscriber connected to the information router and associated with a first of the information routing rules, wherein the information router analyzes the received operation data based on each of the information routing rules, packages a first portion of the received operation data based on the first information routing rule, and sends the first portion of operation data to the first subscriber.

In another embodiment, a method for routing information in work machine environment is disclosed. The method may include receiving, at a information router, operation data from a work machine reflecting operations of the work machine in the work machine environment. The method may also include analyzing the received operation data based on a first information routing rule defined by a first subscriber. The method may further include packaging at least a portion of the received operation data in a predetermined format if the portion of the received operation data conforms to the first information routing rule. The method may also include transmitting the packaged operation data to the first subscriber based on the first information routing rule such that the subscriber only receives operation data identified in the information routing rule.

In yet another embodiment, a work machine environment is disclosed that includes at least one work machine and an information router configured to receive operation data from the at least one work machine. The information router associated with the work machine environment may include a database configured to store a plurality of rules and a processor configured to execute program code stored on a computer readable medium. The program code, when executed by the processor, may analyze the received operation data based on each of the plurality of rules, transmit a first portion of the operation data to a first subscriber when the first portion of the operation data includes information conforming to at least one of the plurality of rules associated with the first subscriber, and transmit a second portion of the operation data to a second subscriber when the second portion of the operation data includes information conforming to at least one of the plurality of rules associated with the second subscriber.

In another embodiment, an information routing system is disclosed that includes a set of subscribers and an information router. The information router may be configured to store a set of parameter data received from a set of work machines operating in the work machine environment. The parameter data may reflect data associated with operation of each respective work machine. Further, the information router may filter the set of parameter data into subsets of parameter data based on information routing rules defined by each of the subscribers in the set of subscribers. Also, the information router may transmit the filtered subsets of parameter data to respective subscribers such that each subscriber only receives a portion of the set of parameter data based on each subscriber's corresponding information routing rule.

### BRIEF DESCRIPTION OF THE DRAWINGS

FIG. 1 illustrates an exemplary work machine environment consistent with certain disclosed embodiments;

FIG. 2 illustrates a flowchart depicting an exemplary disclosed information routing process, consistent with certain disclosed embodiments;

FIG. 3 illustrates a flowchart depicting an exemplary disclosed results analysis process, consistent with certain disclosed embodiments;

FIG. 4 illustrates a flowchart depicting an exemplary rule defining process, consistent with certain disclosed embodiments; and

FIG. 5 illustrates a block diagram of an exemplary process associated with a rule database, consistent with certain disclosed embodiments.

### DETAILED DESCRIPTION

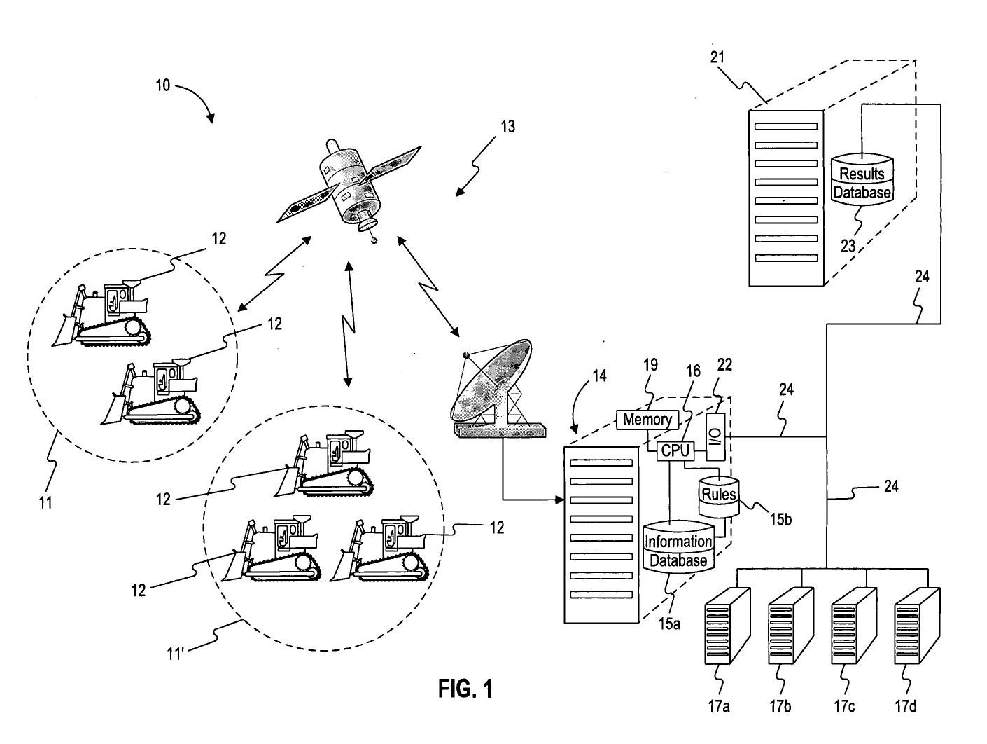

FIG. 1 illustrates an exemplary work machine environment 10 consistent with certain disclosed embodiments. Work machine environment 10 may include components that perform individual tasks that contribute to a work machine environment task, such as mining, construction, transportation, agriculture, manufacturing, or any other type of task associated with other types of industries. For example, work machine environment 10 may include one or more work machines 12 coupled to an information router 14 via a communication network 13. The work machine environment 10 may be configured to monitor, collect, and filter information associated with operation of one or more work machines 12 and distribute the information to one or more back-end systems, such as information router 14, subscribers 17a-17d, and second level information router 21. It is contemplated that additional and/or different components than those listed above may be included in work machine environment 10.

Work machines 12 may each be a fixed or mobile machine configured to perform an operation associated with work machine environment 10. Thus, work machine, as the term is used herein, refers to a fixed or mobile machine that performs some type of operation associated with a particular industry, such as mining, construction, farming, etc. and operates between or within work environments (e.g., construction site, mine site, power plants, etc.) A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. A work machine may be driven by a combustion engine or an electric motor. The types of work machines listed above are exemplary and not intended to be limiting. It is contemplated that work machine environment 10 may implement any type of work machine. Accordingly, although FIG. 1 shows work machines 12 as track type tractor machines, each work machine 12 may be any type of work machine operable to perform a particular function within work machine environment 10. For instance, a first set of work machines 11 may include one or more work machines for performing a first function associated with work machine environment 10 and a second set of work machines 11′ may include one or more work machines for performing a second function associated with work machine environment 10. Although first and second set of work machines are illustrated as track-type tractors, it is contemplated that first and second set of work machines may include additional and/or different types of work machines than those illustrated.

In one embodiment, each work machine 12 may include on-board data collection and communication equipment to monitor, collect, and/or transmit information associated with an operation of one or more components of work machine 12. For example, work machine 12 may include, among other things, one or more monitoring devices, such as sensors, electronic control modules, etc. (not shown), one or more data collection devices (not shown), one or more transceiver devices (not shown), and/or any other such components for monitoring, collecting, and communicating information associated with the operation of work machine 12. Each work machine 12 may also be configured to receive information from off-board systems, such as information router 14, a back-end communication system, etc. The components described above are exemplary and not intended to be limiting. Accordingly, the disclosed embodiments contemplate each work machine 12 including additional and/or different components than those listed above.

Communication network 13 may be a network that provides communications between each work machine 12 and an off-board system, such as information router 14. For example, communication network 13 may communicatively couple work machines 12 to information router 14 across a wireless networking platform such as, for example, a satellite communication system. Alternatively and/or additionally, communication network 13 may include one or more broadband communication platforms appropriate for communicatively coupling one or more work machines 12 to information router 14 such as, for example, cellular, Bluetooth, microwave, point-to-point wireless, point-to-multipoint wireless, multipoint-to-multipoint wireless, or any other appropriate communication platform for networking a number of components. Although communication network 13 is illustrated as a satellite wireless communication network, it is contemplated that communication network 13 may include wireline networks such as, for example, Ethernet, fiber optic, waveguide, or any other type of wired communication network.

Information router 14 may be a system configured to receive, analyze, and distribute operational information from one or more work machines 12 via communication network 13. Operational information may include data reflecting one or more parameters associated with the operation of a respective work machine 12, such as, for example, status data (e.g., engine on/off, parked, stationary, etc.), load weight, engine speed, engine temperature, oil pressure, location, engine hours, tire wear, component fatigue, fluid levels, pressure data, work machine position information, and any other parameter associated with the operation of a work machine.

In one embodiment, information router 14 may include hardware and/or software components that perform processes consistent with certain disclosed embodiments. For example, information router 14 may include one or more databases 15a and 15b, a central processor unit (CPU) 16, one or more computer-readable memory devices 19, and one or more input/output (I/O) devices 22.

Databases 15a and 15b may be memory devices that store data used by information router 14 to perform processes consistent with certain embodiments. For example, database 15a may store raw operational data received from one or more work machines 12. Database 15b may store one or more rules used by information router 14 to sort, filter, and process data stored in database 15a. In one embodiment, the rules may be provided by one or more subscriber terminals 17a-17d and/or by a user or software process associated with information router 14. Further, rules database 15b may include one or more rule templates for developing new rules or modifying existing rules that govern the gathering and distribution of information stored in information database 15a. Although databases 15a and 15b are each illustrated as a single database, it is contemplated that databases 15a and 15b may each include one or more databases, each accessible by a processor device, such as CPU 16. Further, databases 15a and 15b may each include one or more memory management processors that manage reading, writing, and deleting data stored in database 15a. Alternatively, databases 15a and 15b may be configured as a single database having memory locations logically or physically partitioned or segmented for storing work machine operational data and rules.

In certain embodiments, the rules stored in rules database 15b may include hardware logic, software definitions, or a combination of hardware and software configured to gather and sort the information received from one or more work machines 12. For example, the rules may include computer executable scripts that, when executed by a processor, may search data stored in a memory device within information router 14 (e.g., information database 15a) and evaluate the data based on a conditional logic defined by the script. If the information (or portion of information) conforms to the rule, the information is identified and collected as being associated with that particular rule. Operational data may be associated with more than one rule. Also, operational data may be associated with no rules.

In addition to the type of information that is collected, rules may also include formatting instructions, packaging details, frequency of operation, transmission instructions, storing instructions, and other types of information related to the handling of the collected information. For example, a rule may contain instructions to further package operational data according to certain criteria, such as timestamp information (e.g., when the data was collected or received), source identifiers (e.g., identification of the component associated with the operational data), work machine identifiers (e.g., work machine identification number), etc. Alternatively and/or additionally, a rule may specify how often to transmit operational data to a target system, such as one or more subscribers 17a-17d. Each rule may be defined or modified by information router 14 and/or by external systems, such as one or more subscribers 17a-17d. Further, each rule may be selected and/or modified from a list of commonly used rule templates.

CPU 16 may be one or more processors that execute instructions and process data to perform one or more processes consistent with certain disclosed embodiments. For instance, CPU 16 may execute software that enables information router 14 to request and/or receive operational data from one or more work machines 12. CPU 16 may also execute software that stores collected operational data in database 15a according to storage rules. Further, CPU 16 may execute software that analyzes received operational data based on one or more rules stored in rules database 15b. Moreover, CPU 16 may execute software that distributes analyzed operational data according to one or more rules stored in rules database 15b.

Memory 19 may be one or more memory devices that store data or executable code used by CPU 16 to perform processes consistent with certain embodiments. For example, memory 19 may be one or more random access memory devices (RAM) that temporarily store operational data or software code used by CPU 16 when receiving, analyzing, storing, and distributing operation data associated with one or more work machines 12.

Input/output devices 22 may include one or more components for communicating information between information router 14 and other back-end systems. Input/output devices 22 may include, for example, a wireless transceiver, a wired network device, an optical communication device, or any other appropriate device for communicating data signals to and from information router.

Information router 14 may also include other components that perform functions consistent with certain disclosed embodiments. For instance, information router 14 may include a memory device configured to store software applications, such as one or more database programs, a graphical user interface, data acquisition and analysis software, or any other appropriate software applications for operating and/or monitoring work machine environment 10.

Information router 14 may further include one or more components to analyze operational information from work machines 12 using a plurality of rules stored in database 15b. For example, in addition to CPU 16, information router 14 may be configured with on-board logic circuitry that analyzes operational data received from work machines 12.

Information router 14 may also communicate with other systems (e.g., subscribers 17a-17d and second level information router 21) via communication links 24. For example, communication link 24 may include one or more data links that directly connect information router 14 to another system (e.g., subscribers 17a-17d) as part of a point-to-point or point-to-multipoint network. Alternatively and/or additionally, communication link 24 may be include a common access communication platform, such as the Internet, a private intranet, a corporate workgroup, or any other communication platform. Communication link 24 may include electrical wires, twisted pair cables, optical fiber cables, wireless links (e.g., infrared links, Bluetooth connections, satellite communication links, etc.), or any other media appropriate for transmitting data. Further, communication link 24 may be configured with hardware and/or software components that enable data to be transmitted using an analog format, a digital format, a combination thereof, or any other form of data communication.

Subscribers 17a-17d may each be a computer system that is configured to receive data from information router 14 in a manner consistent with the disclosed embodiments. For example, subscribers 17a-17d may each include one or more computer terminals. Alternatively and/or additionally, subscribers 17a-17d may each include personal data assistant systems (PDA), wireless communication devices (e.g., pagers, phones, etc.), notebook computers, diagnostic computer systems, data analyzers, or any other such computing devices configured to receive and process information, such as operational data. In one embodiment, subscribers 17a-17d may each be associated with one or more sections of a business entity. For instance, each of subscribers 17a-17d may be associated with a particular division of a business entity associated with work machine environment 10, such as sales and marketing, design and maintenance, procurement, financial and insurance, supply chain management, production, and/or any other type of business entity that may be associated with work machine environment 10. The business entity may be the same entity associated with information router 14 and/or one or more work machines 12. In one embodiment, subscribers 17a-17d may be associated with a business entity that is affiliated with one or more sets of work machines 12, such as first set 11. Alternatively, different subscribers may be associated with different business entities and/or work machines 12. Accordingly, the above descriptions are exemplary and not intended to be limiting. The disclosed embodiments contemplate any correlation (or none at all) between one or more business entities, and/or sections thereof, and the components of work machine environment 10.

Subscribers 17a-17d may be configured to communicate with information router 14. Thus, subscribers 17a-17d may request operational data from information router 14. In one embodiment, subscribers 17a-17d may each receive the operational data in response to the request and analyze the received data according to the needs of the particular business entity associated with the respective subscriber. For example, subscriber 17a may be associated with a maintenance division responsible for maintaining and repairing one or more work machines 12. Thus, subscriber 17a may receive operational data from information router 14 associated with particular components of a particular work machine 12 or a set of work machines 12. In this example, subscriber 17a may be configured to analyze the received operational data to determine if any action needs to be taken on a particular work machine 12 (e.g., repair, optimization, adjustment, etc.).

Subscribers 17a-17d may each be configured to transmit results of any analysis to one or more of information router 14 and second level information router 21 for storage and/or future access by subscribers 17a-17d and/or routers 14, 21. For instance, following the above example, subscriber 17a may transmit maintenance analysis information to information router 14 or second level information router 21 for storage in a memory device. Subscriber 17c, which may be associated with a procurement division of a business entity, may subsequently access and analyze the maintenance analysis information to determine whether work machine parts are required by the maintenance division.

Subscribers 17a-17d may also each be configured to define one or more rules to filter and collect information based on the needs of one or more associated business divisions or users. Subscribers 17a-17d may each upload the one or more rules to rules database 15b of information router 14. For example, subscriber 17a being associated with maintenance division may require all information related to the operational status of certain components of selected work machines 12. Accordingly, subscriber 17a may define a rule to collect all information related to the operational status of an engine component of one or more work machines 12. Further, subscriber 17a may define an additional rule (or sub-rule) to sort the collected information according to a certain component type or work machine type. The above description is exemplary and not intended to be limiting. The disclosed embodiments contemplate each subscriber 17a-17d being configured to define one or more rules that are associated with different aspects of work machine environment 10. For example, a first subscriber 17a-17d may define a rule that requires information router to 14 to send only a small set of operational data (e.g., positional information only) associated with certain work machines 12, while a second subscriber defines a rule that requires a large set of operation data from one or more work machines 12.

Second level information router 21 may be communicatively coupled to information router 14 and subscribers 17a-17d via communication link 24 and may include one or more components configured to receive and store result data. For example, second level information router 21 may include, for example, a central processing unit (CPU) (not shown), a computer-readable memory (not shown), a random access memory (RAM), input/output (I/O) devices (not shown), etc. Further, second level information router 21 may include a results database 23 that stores result data received from, for example, subscribers 17a-17d. As explained, although second level information router 21 is illustrated as a standalone unit, it is contemplated that second level information router 21 may be included in as an additional component associated with information router 14.

In certain embodiments, second level information router 21 may be configured to perform processes, when executed by a processor, that sort result data in response to a request from one or more subscribers 17a-17d or information router 14. For instance, second level information router 21 may receive a request from subscriber 17b, which may be associated with a design and manufacturing division of a business entity, for result data associated with the maintenance analysis performed by another subscriber (e.g., subscriber 17a) for a particular work machine component. In response to the request, second level information router 21 may search results database 23, collect the requested result data, and provide the result data to subscriber 17b over communication link 24. Alternatively, second level information router 21 may perform analysis processes based on a request from a subscriber 17a-17d. For example, subscriber 17b, associated with a design and manufacturing division, may request that second level information router 21 perform an analysis on result data associated with the maintenance result data received by the other subscriber 17a for the particular work machine component over a predetermined period of time (e.g., the past week, month, etc.). In response, second level information router 21 may analyze the result data in the results database and supply the results of its analysis to subscriber 17b.

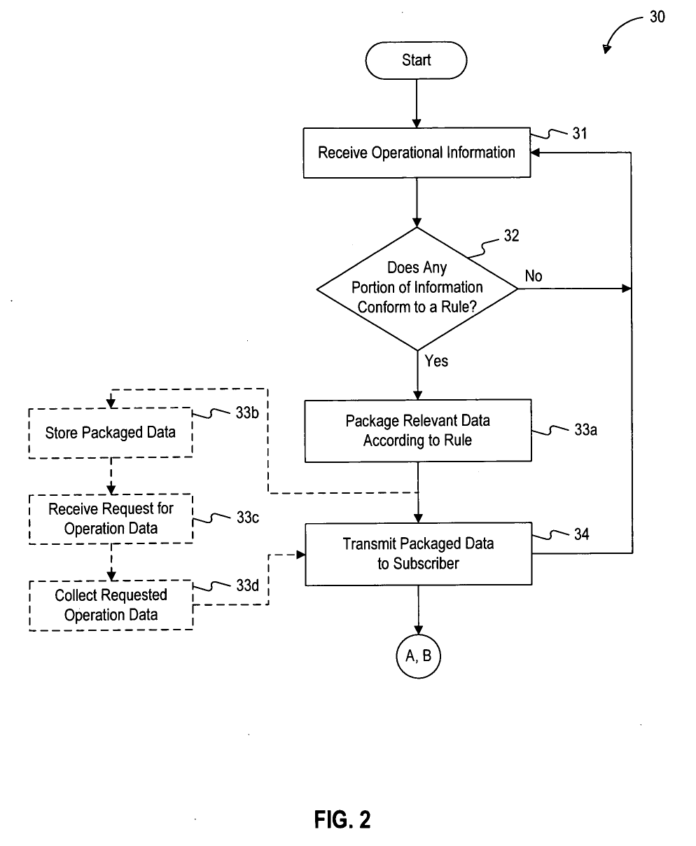

As explained, methods and systems consistent with the disclosed embodiments provide an environment that allows work machine operational data to be collected and routed to particular back-end systems for subsequent processing. FIG. 2 shows a flowchart 30 of an exemplary information routing process consistent with certain disclosed embodiments. As illustrated in FIG. 2, initially, information router 14 receives operation data from one or more work machines 12 (Step 31). For example, information router 14 may receive operation data associated with a particular work machine 12 or associated with a set of one or more work machines 12, such as first and/or second work machine sets 11 and 11′. As mentioned above, operational data may include information associated with an operation, function, and/or status of one or more components of a respective work machine 12. For example, operation data may include information relating to, among other things, information reflecting an operational status of work machine 12 or one or more components thereof, productivity information associated with operation of work machine 12 (e.g., load capacity, actual load, etc.), component health information (i.e., temperature, pressure, vibration, noise, etc.), operator information, or any other such information relevant to work machine operation. Information router 14 may store the received operation data in information database 15a and/or memory 19 for subsequent analysis.

Upon receipt of operational information, information router 14 may analyze the data based on one or more rules stored in rules database 15b to determine conformance of the received information to the rule(s) (Step 32). For example, CPU 16 may execute software that compares the operation data or portions thereof (e.g., one or more parameters) to a rule stored in rules database 15b to determine whether the operation data meets a particular criteria defined by the rule. For instance, a first rule defined by a first subscriber 17a-17b may request selected parameters (P1, P2, and P3) associated with a particular type of work machine 12 (e.g., Type 1) be delivered to the first subscriber at a particular time period. Thus, in this example, if the operation data received by information router 14 includes a parameter set including parameters [P1, P2, P3, P10, P14, and P20] from a first type of work machine 12, CPU 16 may determine that parameters P1, P2, and P3 meet the criteria of the first rule. If, however, the parameter set was sent from a work machine 12 of a second type, the parameters P1, P2, and P3 included in the received parameter set may not meet the criteria of the first rule.

If the operation data conforms to the rule (Step 32; Yes), CPU 16 may execute software that packages the relevant operation data (e.g., certain parameters included in the operation data) according to a predetermined format (Step 33a). For example, the relevant operation data may be packaged according to one or more packaging guidelines specified in the rule, such as predetermined formatting guidelines defined by a subscriber 17a-17d associated with the rule. Thus, in certain embodiments, information router 14 may be configured to package operation data in a format appropriate and/or compatible with the subscriber associated with the given rule. For instance, a subscriber 17a-17d may define a package format to ensure that the received information is ready for further dissemination or analysis. For example, subscriber 17a may request to have operation data packaged according to a first format (e.g., according to work machine ID number), while subscriber 17b may request to have operation data provided in a second format (e.g., according to component type).

Alternatively and/or additionally, in one exemplary embodiment, CPU 16 may execute software that stores the operation data (either packaged or unpackaged) in a memory device, such as computer readable memory device 19 and/or information database 15a (Step 33b). In one embodiment, CPU 16 may execute software that stores the operation data in a format and/or structure according to one or more predefined storage rules.

At some point, information router 14 may receive a request for operation data (Step 33c). The request may be a request from a subscriber 17a-17d for particular operation data. Alternatively, information router 14 may execute software according to a rule defined by one or more subscribers 17a-17d that initiates the request for operation data based on another rule. For example, CPU 16 may execute a software program that periodically generates a request for certain operation data for a first subscriber 17a-17d. The request may be received and processed by other software executed by CPU 16 (or another processor device) that performs rule analysis processes consistent with those described above in connection with Step 32.

Based on the request, CPU 16 executes software that accesses the memory device storing the operation data (e.g., information database 15a) to search for the operation data indicated in the request and a corresponding one or more rules. CPU 16 may collect the requested operation data from the memory device for subsequent transmission to an appropriate target element (e.g., subscriber 17a-17d) based on the request and/or rule(s) (Step 33d). For example, a subscriber 17c associated with a design and manufacturing division may require all parameter data associated with a set of work machines 12 to determine whether certain components of a work machine may need modification due to reliability problems. In this example, the exemplary subscriber 17c may provide the request to information router 14, which, in turn, filters the received and/or stored operation data for parameter data corresponding to those identified by a rule defined by the design and manufacturing division. Once located, the appropriate parameter data is collected and packaged for subsequent transmission to subscriber 17c in accordance with its specified rule(s).

Once the relevant operation data is packaged (e.g., Steps 33a and 33d), information router 14 may transmit the packaged data to a target subscriber 17a-d associated with a corresponding rule (Step 34). In one embodiment, information router 14 may transmit the packaged operation data to particular subscribers 17a-17d according to reporting rules affiliated with each operation data collecting rule defined by the subscribers 17a-17d. For instance, CPU 16 may execute software that recognizes one or more reporting rules affiliated with each subscriber 17a-17d based on the type of collected operation data. Thus, information router 14 may transmit a first set of packaged operation data to subscriber 17a according to a first reporting rule (e.g., immediate transmission, periodic transmission, delayed transmission, conditional transmissions, etc.). Further, information router 14 may transmit a second set of packaged operation data to subscriber 17b according to a second reporting rule. Therefore, in certain embodiments, information router 14 may be configured to execute rule analysis processes for collecting, storing, packaging, and disseminating operation data.

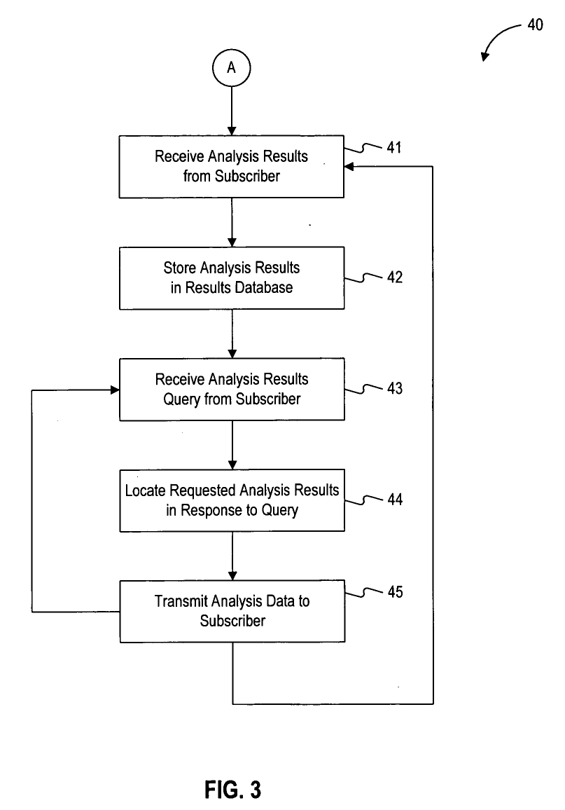

As explained, subscribers 17a-17d may process operation data received from information router 14 based on each subscriber's affiliation with a particular section of a business entity. For example, subscriber 17a may be associated with a maintenance division of a business entity, and thus performs diagnostic analysis on received operation data. Subscriber 17b, on the other hand, may be associated with a leasing division of a business entity, and thus performs analysis associated with its business goals and requirements. In certain embodiments, the results of the analysis and processing performed by one or more of subscribers 17a-17d may be shared with other components of work machine environment 10. For example, a user operating subscriber 17a may have a need for reviewing analysis performed by a different user or business section associated with subscriber 17d. As such, methods and systems consistent with certain disclosed embodiments enable results of analysis performed by subscribers 17a-17d to be shared through information router 14 and/or second level information router 21. FIG. 3 illustrates a flowchart 40 of an exemplary result analysis process consistent with certain disclosed embodiments.

Initially, second level information router 21 may receive results of operation data analysis performed by one or more subscribers 17a-17d (Step 41). It should be noted, although FIG. 3 is described in connection with processes performed by second level information router 21, the processes described in connection with FIG. 3 may also be performed by information router 14. Upon receipt of the analysis results, second level information router 21 may store the analysis results in results database 23 (Step 42). In certain embodiments, second level information router 21 may store the analysis results in database 23 according to selected arrangement and array formats to allow more efficient retrieval of the stored data. Any type of storing and configuration techniques may be implemented to facilitate the storing of the analysis result data by second level information router 21.

In one embodiment, second level information router 21 may receive an analysis results query from one or more subscribers 17a-17d (Step 43). The analysis results query may identify a particular subscriber 17a-17d, type of analysis performed, business division, etc. For example, a first subscriber (e.g., subscriber 17a) may provide an analysis results query requesting the results of a diagnostic analysis process performed by a particular subscriber and/or business division (e.g., subscriber 17b) for a particular work machine component. Other information may be included in the analysis result query that identifies the particular type of result data being requested by a subscriber 17a-17d.

Based on the received query, second level information router 21 may search, locate, and collect the requested analysis result data (Step 44). As a result, second level information router 21 may transmit the collected analysis result data to the requesting subscriber 17a-17d (Step 45). For example, a subscriber 17a associated with the maintenance division may request the analysis results related to maintenance costs associated with maintenance analysis processes performed by the sales and marketing division. Accordingly, second level information router 21 may locate the analysis results supplied by the sales and marketing division and transmit the information to the maintenance division's associated subscriber.

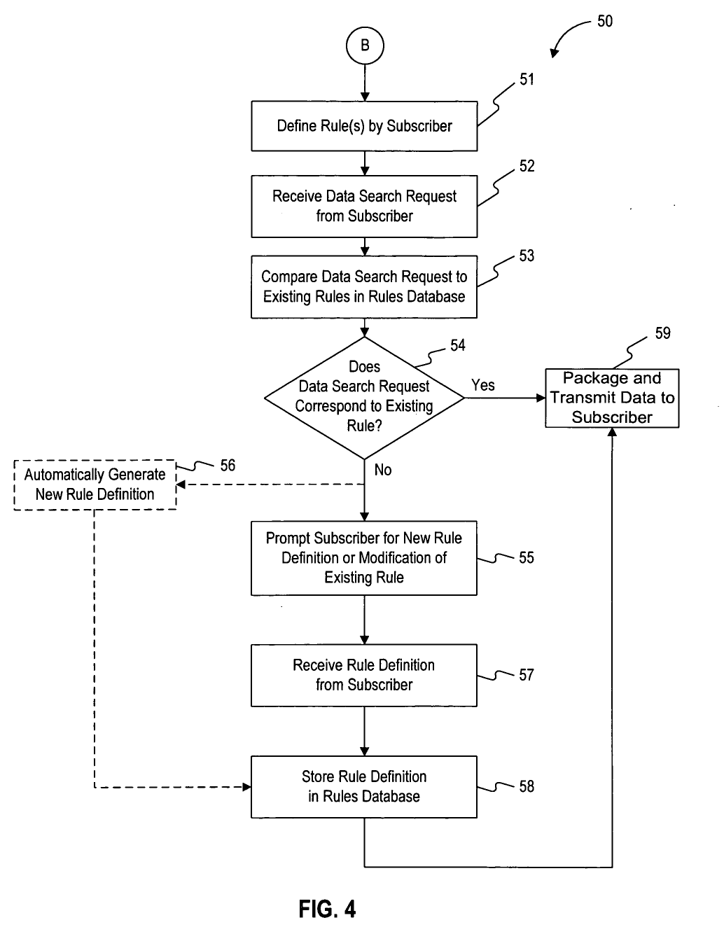

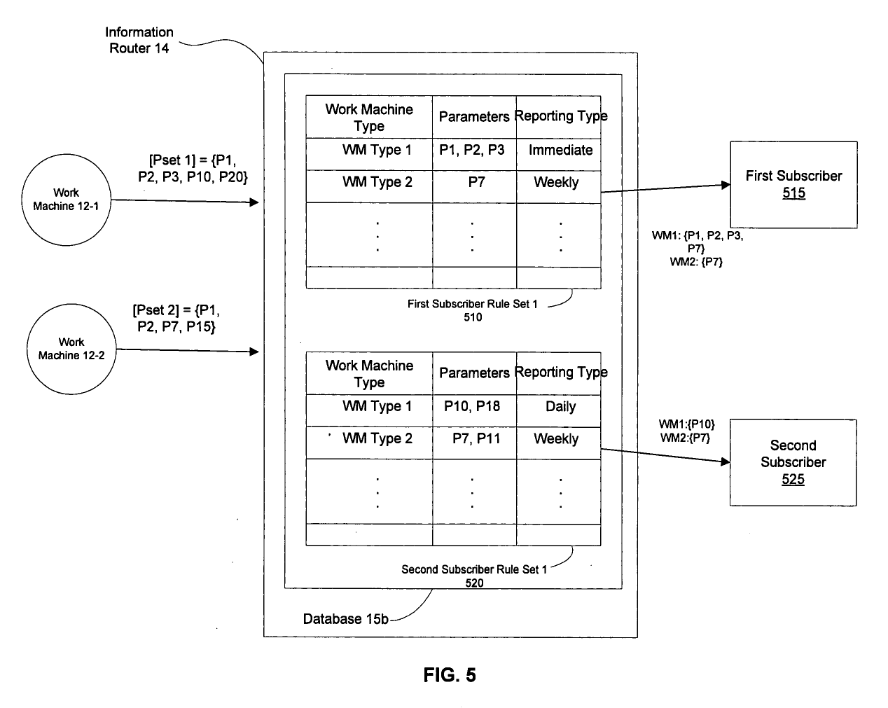

As previously described, methods and systems consistent with certain embodiments enable subscribers 17a-17d to define one or more rules that govern how information router 14 collects, stores, packages, and/or transmits operation data to respective subscribers 17a-17d. FIG. 4 illustrates a flowchart 50 of an exemplary rule defining process consistent with these embodiments. Each subscriber 17a-17d may define, via a user or a software process, one or more rules that govern the type of operation data a respective subscriber is to receive from information router 14, when the data is to be received, and/or what format the data is to be received (Step 51). Each subscriber 17a-17d may define different criteria for each rule. For instance, FIG. 5 shows a block diagram of exemplary rules that may be defined by two exemplary subscribers and stored by information router 14 in database 15b. As shown as an example, database 15b may store a first subscriber rule set 510 and a second subscriber rule set 520 based on rules defined by the first and second subscribers, respectively. First rule set 510 defines criteria that instructs information router 14 to collect, store, and send parameter data (e.g., parameters P1, P2, and P3) associated with a first type of work machine (WM Type 1, i.e., work machine 12-1), immediately to the first subscriber 515. As such, when information router 14 receives operation data from work machine 12-1, it determines whether the received information includes parameter data associated with parameters P1, P2, and P3, and if so, sends this information to first subscriber 515. Further, first subscriber rule set 510 may also define a rule for a second type of work machine (WM Type 2, work machine 12-2). Thus, rule set 510 instructs information router 14 to send parameter P7 associated with the second type of work machine 12-2 on a weekly basis to first subscriber 515. Second subscriber rule set 520 includes respective rule criteria rules for both first and second types of work machines 12-1 and 12-2, respectively. Accordingly, information router 14 may be configured to store one or more rules defined by subscribers 17a-17d that govern what operation data is collected and stored, and how it is reported to the respective subscribers. Subscribers 17a-17d may provide a rule to information router 14 over communication link 24.

In the example shown in FIG. 5, work machine 12-1 provides parameters P1, P2, P3, P10, and P20 to information router 14, and work machine 12-2 provides parameters P1, P2, P7, and P15 to information router 14. Based on the exemplary rules sets 510 and 520, information router 14 provides first subscriber 515 with parameters P1, P2, P3, and P7 associated with first work machine 12-1 and parameter P7 associated with work machine 12-2. Further, information router 14 provides second subscriber 525 with parameter P10 from first work machine 12-1 and parameter P7 from second work machine 12-2. It should be noted that the rules described above and shown in FIG. 5 are exemplary, and are not intended to be limiting. Additional criteria may be implemented in the disclosed embodiments. For example, a subscriber 17a-17d may further define rule criteria to include component types of a particular work machine type. Thus, first subscriber rule set 510 may further include another criterion that directs information router 14 to provide certain parameter data associated with a particular component of first work machine 12-1, but not the same type of parameter data of a different component on first work machine 12-1.

In another embodiment, information router 14 may not include a rule that is associated with a received request for certain operation data from a subscriber. In such instance, embodiments are disclosed that enable information router 14 to receive new rules (or modify existing rules) based on criteria provided by a subscriber. For instance, as illustrated in FIG. 4, information router 14 may receive an operation data request from one or more subscribers 17a-17d (Step 52). Based on the request, information router 14 may access and search the existing rules stored in rules database 15b to determine whether a given rule is defined that provides the requested operation data identified in the request to the given subscriber that generated the request (Step 53). Accordingly, information router 14 determines whether the data search request corresponds to an existing rule in rules database 15b (Step 54). For example, a subscriber associated with a maintenance division of a business entity may require information related to the operation of a new component recently installed on one or more work machines 12. In this example, information router 14 may determine that rules database 15b does not include an existing rule that matches the requested operation data associated with the new component.

If information router 14 determines that a corresponding rule does exist in rules database 15b (Step 54; Yes), information router 14 may collect and package the operation data identified in the request and transmit the packaged data to the requesting subscriber, in a manner similar to that described above in connection with Steps 33a and 34 of FIG. 2 (Step 59). On the other hand, if information router 14 determines the request does not include information that matches an existing rule (Step 54; No), information router 13 may prompt the requesting subscriber to define a new rule associated with the information request (Step 55). In response to the prompt, the requesting subscriber 17a-17d may define, via a user or software process executed by a processor, a new rule associated with the requested operation information, and provide the new rule to information router (Step 57). Alternatively, subscriber 17a-17d may provide information router 14 with instructions for modifying an existing rule stored in rules database 15b. Based on the information received from the requesting subscriber 17a-17d, information router 14 may store the new rule, or modify an existing rule, in database 15b (Step 58). Once the new rule has been defined or an existing rule modified, information router 14 may package the relevant operation data and transmit the packaged data to the requesting subscriber 17a-17d in a manner consistent with the processes described above in connection with Steps 33a and 34 of FIG. 2.

In one exemplary embodiment, if information router determines the request does not match an existing rule (Step 54; No), information router 14 may execute software that is configured to automatically generate a new rule, or modify an existing rule (Step 56), thus replacing the need for the requesting subscriber to perform these functions.

### INDUSTRIAL APPLICABILITY

Methods and systems consistent with the disclosed embodiments enable vast amounts of work machine-related data to be filtered and intelligently routed to back-end systems that have a need for the selected information. Work machine environments that employ processes and elements consistent with certain disclosed embodiments allow a subscriber to define one or more rules that govern how a central information router feeds work machine operation data to the subscriber. Additionally, certain embodiments enable the subscriber to provide results of analysis performed on received operation data to a second level operation router that is accessible by other back-end systems, such as other subscribers.

Although the disclosed embodiments are described in association with work machine environment 10, the disclosed information routing system functions described herein may be applicable to any environment where it may be desirable to distribute information to various entities associated with the environment. Specifically, the disclosed information routing system may collect, filter, and distribute information from a single server to one or more subscribers of an information distribution environment to reduce information overload on the server.

The information routing system described above enables a computer system, such as a back-end server system, to transmit “real-time” operation data from a work machine to an end-user as it is being received or on a periodic basis. Thus, problems associated with information overload may be significantly reduced as a subscriber is no longer required to utilize resources to filter and sort large amounts of operation data to locate the information needed to perform its analysis. Instead, the disclosed embodiments enable the subscriber to direct an information router to send only the information it requires, and thus reducing the amount of data that is received by the subscriber, as well as the amount of information transmitted on the back-end network (e.g., communication link 24). As a result, embodiments associated with information routing system 14 may reduce or eliminate the time and productivity losses associated with end-users sorting through large amounts of raw data. “Real-time” as the term is used herein, describes a respective time associated with a current operation of a work machine 12. For example, real-time may include time adjusted by some delay, such as, communication and/or propagation delays associated with processing data and/or signals within the work machine 12 and/or communication network 13. For instance, a work machine 12 may collect operation data in real-time during a current operation within work machine environment 10. Further, work machine 12 may transmit this operation data off-board in real-time over communication network 13. Information router 14 may receive the operation data sent by work machine 12 in real-time that may include any delays associated with the transmission over communication network 13.

Furthermore, the disclosed embodiments associated with information routing system 14 may increase the reliability of a work machine environment 10. For example, because each subscriber 17a-17d receives customized, packaged, and filtered information in a format based on their specifications, subscribers 17a-17d do not have to spend resources in reformatting the received operation data to locate certain information. Thus, for example, adjustments or repairs can be scheduled for a particular work machine 12 quicker, business reports may be generated faster, etc. allowing a business entity or entities to manage the information received from work machines 12 more efficiently and effectively.

In addition, personnel and equipment productiveness may be increased as business entities associated with subscribers 17a-17d receive up-to-the-minute pre-packaged information that is ready for further analysis, based on the specifications or priorities of the work machine environment. For example, because each of subscribers 17a-17d determine the manner in which the information is packaged and formatted, integration of real-time data into existing software programs may be configured through the definition and storage of application specific rules within rules database 15b.

It will be apparent to those skilled in the art that various modifications and variations can be made to the disclosed system and method for information routing without departing from the scope of the disclosed embodiments. For example, although certain embodiments are disclosed with regard to a single business entity, multiple business entities may be involved in performing the information routing aspects associated with the disclosed embodiments. For example, information router 14 may be associated with a first business entity, and one or more subscribers 17a-17d may be associated with a second business entity. Further, second level information router 21 may be associated with the same or different business entity associated with information router 14 and/or one or more subscribers 17a-17d.

In another embodiment, second level information router 21 may be configured with a rules database that stores one or more rules that govern the dissemination of result data received from subscribers 17a-17d. Each of the second level information routing rules may be defined and provided by each of the subscribers 17a-17d. In this embodiment, second level information router 21 may execute a software process that automatically transmits result data originating from one or more subscribers 17a-17d to one or more target subscribers 17a-17d, based on each target subscriber's second level information routing rules. For example, subscriber 17a may define a rule in second level information router 21 that directs router 21 to send any result data provided by subscriber 17b that is associated with certain types of operation data (e.g., certain parameters) and/or certain types of analysis (e.g., maintenance reports for certain work machines 12, work machine components, etc.)

Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

1. An information routing system for a machine environment, comprising:
an information router configured to receive operation data associated with a machine over a communication network, the information router including a database storing information routing rules that each govern how the information router is to collect and deliver information received from the machine; and
a first subscriber connected to the information router and associated with a first information routing rule,
wherein the information router analyzes the received operation data based on each of the information routing rules, packages a first portion of the received operation data based on the first information routing rule, and sends the first portion of operation data to the first subscriber.

2. The system of claim 1, wherein the operation data includes data reflecting at least one operational characteristic of the machine collected during real time operations in the machine environment.

3. The system of claim 2, wherein the machine is further configured to transmit the operation data over the communication network during the real time operations in the machine environment.

4. The system of claim 1, wherein the information router modifies the first information routing rule in response to a request from the first subscriber.

5. The system of claim 1, wherein the first subscriber defines the first information routing rule and provides the first information routing rule to the information router.

6. The system of claim 1, further including a second subscriber associated with a second information routing rule and wherein the information router transmits a second portion of the operation data to the second subscriber based on the second information routing rule.

7. The system of claim 6, wherein the received operation data includes a set of parameter data associated with the machine, and the first and second portions of the operation data includes at least one common parameter data.

8. The system of claim 1, further including a second level information router in communication with the first subscriber, wherein the second level information router receives results of an analysis performed on the first portion of operation data by the first subscriber and stores the received analysis results.

9. The system of claim 8, wherein the second level information router sends the analysis results to a second subscriber associated with a second information routing rule stored in the database of the information router.

10. The system of claim 8, wherein the second level information router sends the analysis results to the second subscriber based on a request for the analysis results from the second subscriber.

11. The system of claim 8, wherein the second level information router sends the analysis results to the second subscriber based on a second level information routing rule associated with the second subscriber and stored in the second level information router.

12. The system of claim 1, further including a second machine configured to send second operation data to the information router associated with operations of the second machine in the machine environment, and wherein the information router analyzes the received second operation data based on the first information routing rule and sends a portion of the second operation data to the first subscriber based on the first information routing rule.

13. The system of claim 1, further including a second machine configured to send second operation data to the information router associated with operations of the second machine in the machine environment, and wherein the information router analyzes the received second operation data based on a second information routing rule and sends a portion of the second operation data to a second subscriber based on the second information routing rule.

14. A method for routing of machine information in a machine environment, comprising:
receiving, at an information router, operation data from a machine reflecting operations of the machine in the machine environment;
analyzing the received operation data based on a first information routing rule defined by a first subscriber;
packaging at least a portion of the received operation data based on the first information routing rule; and
transmitting the packaged operation data to the first subscriber based on the first information routing rule.

15. The method of claim 14, wherein the operation data includes data reflecting at least one operational characteristic of the machine collected during real time operations in the machine environment.

16. The method of claim 14, further including modifying the first information routing rule in response to a request from the first subscriber.

17. The method of claim 16, wherein modifying the first information routing rule further includes creating a second information routing rule based on the request from the first subscriber.

18. The method of claim 14, wherein the predetermined format is previously defined by the first subscriber.

19. The method of claim 14, further including:
analyzing by the first subscriber the packaged operation data to produce result data; and
providing the result data to a database that is accessible by a second subscriber.

20. The method of claim 19, further including:
transmitting the result data to the second subscriber in response to a request from the second subscriber.

21. The method of claim 19, further including:
transmitting the result data to the second subscriber based on a second level information routing rule defined by the second subscriber.

22. The method of claim 14, wherein packaging the portion of the received operation data further includes:
storing the portion of the received operation data in a database; and
packaging and transmitting the stored portion of the operation data to the subscriber after a predetermined period of time identified in the first information routing rule.

23. The method of claim 14, wherein receiving operation data includes:
receiving operation data from a set of machines, the operation data reflecting operations associated with each of the machine in the machine environment, and
wherein the first subscriber defines a set of rules governing how the information router transmits the received operation data from each of the machines to the first subscriber.

24. A machine environment, comprising;
at least one machine;
an information router configured to receive operation data from the at least one machine and including:
a database configured to store a plurality of rules, and
a processor, when executing program code stored on a computer readable medium, configured to:
analyze the received operation data based on each of the plurality of rules,
transmit a first portion of the operation data to a first subscriber when the first portion of the operation data includes information conforming to at least one of the plurality of rules associated with the first subscriber, and
transmit a second portion of the operation data to a second subscriber when the second portion of the operation data includes information conforming to at least one of the plurality of rules associated with the second subscriber.

25. The machine environment of claim 24, further comprising a second level information router connected to the first and second subscribers and configured to:
receive analysis data from the first subscriber, the analysis data reflecting an analysis performed on the first portion of the operation data by the first subscriber;
store the received analysis data; and
transmit the analysis data to the second subscriber.

26. A system for routing information in a machine environment, comprising:
a set of subscribers; and
an information router configured to:
store a set of parameter data received from a set of machines operating in the machine environment, the parameter data reflecting data associated with operation of each respective machine,
filter the set of parameter data into subsets of parameter data based on information routing rules defined by each of the subscribers in the set of subscribers, and
transmit the filtered subsets of parameter data to respective subscribers such that each subscriber only receives a portion of the set of parameter data based on each subscriber's corresponding information routing rule.

27. The system of claim 26, further including a second information router that stores result data provided by each of the subscribers, the result data for each subscriber reflecting results of an analysis performed on the respective portion of the set of parameter data received by the respective subscriber, wherein each subscriber is configured to receive result data provided by at least one of the other subscribers to the second information router.

28. A computer-readable medium storing instructions that, when executed by a processor, perform a method for routing information in a machine environment, the method comprising:
storing a set of parameter data received from a set of machines operating in the machine environment, the parameter data reflecting data associated with operation of each respective machine,
filtering the set of parameter data into subsets of parameter data based on information routing rules defined by each of a set of subscribers; and
transmitting the filtered subsets of parameter data to respective subscribers such that each subscriber only receives a portion of the set of parameter data based on each subscriber's corresponding information routing rule.
